(19) United States
(12) Patent Application Publication
(10) Pub. No.: US 2025/0259332 A1
(43) Pub. Date: Aug. 14, 2025

(54) SYSTEMS, DEVICES, AND METHODS FOR PREDICTING LANE LINE LOCATIONS

(71) Applicant: Stack AV Co., Mount Pleasant, PA (US)

(72) Inventor: Kevin Lee WYFFELS, Victor, NY (US)

(73) Assignee: Stack AV Co., Mount Pleasant, PA (US)

(21) Appl. No.: 18/438,160

(22) Filed: Feb. 9, 2024

(51) Int. Cl. G06T 7/77; G06V 20/56

(52) U.S. Cl. CPC G06T 7/77; G06V 20/588; G06T 2207/20076; G06T 2207/30256

(57) ABSTRACT

A method for predicting lane line locations, the method comprises: detecting, by one or more sensors on a vehicle, image data comprising a first portion of one or more lane lines of a roadway; determining a plurality of location points indicating locations of the one or more lane lines based on the image data; determining one or more continuous functions to respectively represent the one or more lane lines based on the plurality of location points, wherein determining the one or more continuous functions comprises determining a plurality of responsibility metrics indicating respective likelihoods that each continuous function represents a lane line; and predicting a location of a second portion of one or more lane lines on the roadway based on the one or more continuous functions and the plurality of responsibility metrics.

### FIELD

This disclosure relates generally to image processing and more specifically to performing predictive analytics based on image data for use in vehicle navigation.

### BACKGROUND

Autonomous vehicles must be able to accurately determine the location of lane lines on the roadway, including both lane lines defining the lane in which the vehicle is traveling as well as other lane lines defining lanes adjacent to or otherwise nearby the vehicle. Lane lines delineate the boundaries and directions of traffic flow on the roads. Accordingly, to maintain the correct position within a lane, safely execute lane change maneuvers, navigate along curves, and adapt to changes in lane position and shape, autonomous vehicles must be able to identify the lane lines surrounding the vehicle.

### SUMMARY

In order for autonomous vehicles to be able to perform partially-autonomous and fully-autonomous navigation in a safe and reliable manner, techniques for accurate, fast, and computationally efficient determination of lane line positions are needed. Furthermore, in order to enable automated navigation at high speeds, there is a need for systems and methods for quickly and accurately inferring lane line locations and/or predicting lane line locations for lane lines that cannot be directly detected by sensors of a vehicle. That is, there is a need for systems that can infer lane line locations based on image data and predict lane line locations for lane lines that are at least partially located outside the effective sensor range of a vehicle, around a curve and not visible to the vehicle sensors, and/or occluded by an object and otherwise not visible to the vehicle sensors.

Described herein are systems, devices, methods, and non-transitory computer readable storage media for inferring and/or predicting lane line locations. An exemplary system may be configured to detect image data that includes a first portion of one or more lane lines on a roadway using one or more sensors positioned on a vehicle. The system may determine location data points that correspond to lane line locations based on the image data and model the lane lines as continuous functions based on the location data points. In some embodiments, the system may determine a predefined number of continuous functions, assign responsibility metrics (e.g., weights or mixing coefficients to each function), and filter out those functions determined unlikely to represent existing lane lines based on the responsibility metrics. The system may further predict a location of a second portion (e.g., an undetected portion, a y-coordinate at an arbitrary x-coordinate query point, etc.) of one or more lane lines on the roadway based on the one or more continuous functions and the plurality of responsibility metrics.

The techniques described herein provide a number of technical advantages. For instance, each of the continuous functions representing a lane line may include a linear combination of (optionally) non-linear basis functions. By constraining the continuous functions to a linear combination of fixed, nonlinear basis functions of the input variables, the continuous functions may be linear in their parameters to facilitate efficient inference and/or prediction but remain nonlinear functions of the input variables to retain the expressive power of the model. Further, the continuous functions may be determined iteratively, frame by frame, based on the image data. Each iteration is inexpensive, and the recursion over time may allow for a relatively accurate prior estimate derived from the posterior at the previous time step, which should enable relatively fast convergence. Accordingly, by utilizing the described inference and/or prediction techniques and the described iterative processing methods, the systems and methods described herein may improve the functioning of a computer by increasing computer processing speed, reducing processing and power requirements, and reducing memory requirements, as all that may be required for each iteration is an initial set of hyperparameters, which may be initialized according to various assumptions for a first iteration or based on hyperparameters stored in memory from a previous iteration, along with a frame of image data. By improving the accuracy, speed, and efficiency of lane line inference and/or prediction, the techniques described herein may also improve the technology of autonomous vehicles (and robotics more generally) by allowing improved inference and/or prediction techniques to replace the need for more accurate and more numerous sensors for direct detection of lane lines.

In some aspects, an exemplary method for predicting lane line locations comprises: detecting, by one or more sensors on a vehicle, image data comprising a first portion of one or more lane lines of a roadway; determining a plurality of location points indicating locations of the one or more lane lines based on the image data; determining one or more continuous functions to respectively represent the one or more lane lines based on the plurality of location points, wherein determining the one or more continuous functions comprises determining a plurality of responsibility metrics indicating respective likelihoods that each continuous function represents a lane line; and predicting a location of a second portion of one or more lane lines on the roadway based on the one or more continuous functions and the plurality of responsibility metrics.

Optionally, determining the plurality of responsibility metrics comprises: determining a respective probability that each of the location points corresponds to each of the one or more continuous functions; and determining a responsibility metric corresponding to each of the one or more continuous functions based on the probability that each of the location points corresponds to the respective continuous function.

Optionally, determining the one or more continuous functions comprises determining that at least one of the one or more continuous functions does not represent a lane line based on the plurality of responsibility metrics; and filtering the at least one continuous function from the one or more continuous functions.

Optionally, determining the one or more continuous functions comprises: determining a first plurality of hyperparameters at a first time; determining a respective probability that each of the location points corresponds to each of the one or more continuous functions based on the first plurality of hyperparameters; determining an updated plurality of hyperparameters at a second time after the first time based on the respective probability that each of the location points corresponds to each of the one or more continuous functions based on the first plurality of hyperparameters.

Optionally, the updated plurality of hyperparameters is set to maximize a variational distribution over a plurality of parameters of the one or more continuous functions.

Optionally, determining the one or more continuous functions comprises: determining that a convergence criterion is not satisfied based on an initial joint probability distribution evaluated at a first expected value of the plurality of parameters determined based on the first plurality of hyperparameters and an updated joint probability distribution evaluated at a second expected value of the plurality of parameters determined based on the updated plurality of hyperparameters; replacing the first plurality of hyperparameters with the updated plurality of hyperparameters; and determining a second updated joint probability distribution at a third time based on the plurality of updated hyperparameters.

Optionally, determining that the convergence criteria is not satisfied comprises determining that a difference between the updated probability distribution and the initial probability distribution exceeds a threshold.

Optionally, the method comprises: controlling an autonomous vehicle based on the predicted location of the second portion of the one or more lane lines.

Optionally, the method comprises: displaying the predicted location of the second portion of the one or more lane lines on a user interface of a vehicle.

Optionally, determining the plurality of location points indicating locations of the one or more lane lines based on the image data the image data comprises: determining a two-dimensional grid of cells based on the image data; assigning at least one semantic label and at least one confidence value associated with the at least one semantic label to each cell, wherein the at least one semantic label and the at least one confidence value are indicative of whether the cell includes a lane line; and extracting a centroid from each cell that is assigned a semantic label indicating that the cell includes a lane line and a confidence value exceeding a threshold.

Optionally, the one or more continuous functions comprise a continuous parametric function.

Optionally, the continuous parametric function comprises a polynomial function.

Optionally, the one or more continuous functions are determined for at least a subset of a predefined maximum number of lane lines.

Optionally, predicting the location of the second portion of the one or more lane lines comprises predicting a probability distribution over an output of the one or more continuous functions.

Optionally, predicting the location of the second portion of the one or more lane lines comprises predicting an output based on a function that comprises a two-dimensional curve corresponding to the location of the one or more lane lines along the roadway.

Optionally, the predicted location of the second portion of the one or more lane lines based on the one or more continuous parametric functions is limited to a predefined distance from the vehicle.

Optionally, predicting the location of the second portion of the one or more lane lines comprises predicting a location envelope of the one or more lane lines based on an error function.

Optionally, predicting the location of the second portion of the one or more lane lines comprises predicting a location of at least one lane line in a region out of range of the one or more sensors.

In some aspects, an exemplary system for predicting lane line locations comprises one or more processors and memory storing one or more computer programs that include computer instructions, which when executed by the one or more processors, cause the system to: detect, by one or more sensors on a vehicle, image data comprising a first portion of one or more lane lines of a roadway; determine a plurality of location points indicating locations of the one or more lane lines based on the image data; determine one or more continuous functions to respectively represent the one or more lane lines based on the plurality of location points, wherein determining the one or more continuous functions comprises determining a plurality of responsibility metrics indicating respective likelihoods that each continuous function represents a lane line; and predict a location of a second portion of one or more lane lines on the roadway based on the one or more continuous functions and the plurality of responsibility metrics.

In some aspects, an exemplary non-transitory computer readable storage medium stores instructions for predicting lane line locations, the instructions configured to be executed by one or more processors of a computing system to cause the system to: detect, by one or more sensors on a vehicle, image data comprising a first portion of one or more lane lines of a roadway; determine a plurality of location points indicating locations of the one or more lane lines based on the image data; determine one or more continuous functions to respectively represent the one or more lane lines based on the plurality of location points, wherein determining the one or more continuous functions comprises determining a plurality of responsibility metrics indicating respective likelihoods that each continuous function represents a lane line; and predict a location of a second portion of one or more lane lines on the roadway based on the one or more continuous functions and the plurality of responsibility metrics.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary system for predicting lane line locations according to some embodiments.

FIG. 2 illustrates an exemplary method for predicting lane line locations according to some embodiments.

FIGS. 3A and 3B illustrate exemplary image data and predicted lane line locations based on the image data according to some embodiments.

FIGS. 4A and 4B illustrate performance of an exemplary lane line location prediction model with 3rd order polynomial basis functions run over fully synthetic data according to some embodiments.

FIGS. 5A and 5B illustrate the corresponding prediction errors and predicted one-standard-deviation error bounds for the same synthetic data examples illustrated in FIGS. 4A and 4B according to some embodiments.

FIGS. 6A and 6B illustrate results of the same fully synthetic problem setup illustrated in FIGS. 4A-4B and 5A-5B run over fully synthetic data generated from two intersecting polynomials according to some embodiments.

FIG. 7 illustrates an exemplary computing system according to some embodiments.

### DETAILED DESCRIPTION

Described herein are systems, devices, methods, and non-transitory computer readable storage media for predicting lane line locations. An exemplary system may include one or more sensors positioned on a vehicle, such as an autonomous vehicle, configured to detect image data of the vehicle's environment. The image data may include a first portion of one or more lane lines, and the system may be configured to process the image data to infer and/or predict lane line locations on the roadway. Processing the image data may include extracting location data points associated with lane lines from the image data, determining continuous functions that accurately represent each of the lane lines in the detected data, and predicting lane line locations at arbitrary query points along the roadway based on the determined continuous functions.

Extracting the location data points associated with the lane lines from the image data may include projecting a bird's eye view (BEV) grid and/or point cloud over the detected image data and assigning semantic labels and/or confidence scores to grid cells or points of the BEV grid or point cloud. The semantic labels and confidence values may be indicative of whether a respective cell or point includes a lane line, and the system may be configured to extract those cells/points from the data that include a lane line label and/or a confidence value exceeding a threshold indicative of the point likely corresponding to a detected lane line.

Based on the extracted data, the system may determine continuous functions to represent the lane lines associated with the extracted data points. Specifically, to determine the continuous functions, the system may initialize a plurality of hyperparameters, determine a respective probability that each of the location points extracted from the image data corresponds to each of the one or more continuous functions (as used herein, these respective probabilities may be referred to as responsibilities) based on the hyperparameters, and update the estimates of the hyperparameters for each continuous function to those values that maximize the variational distribution given the expected value of the responsibilities solved for in the previous step.

The two steps following initialization of the hyperparameters may be iteratively performed until a convergence criteria is satisfied, and, once the convergence criteria is satisfied, the computing system may determine which functions correspond to existing lane lines based on responsibility metrics (which may be determined based on the responsibilities), filter out those functions that do not correspond to existing lane lines from the analysis, and predict the distribution over the output of the remaining functions at new inputs. That is, the system may predict the lane line locations at new query points. The inferred and/or predicted lane line locations may be utilized by the system to, for instance, control an autonomous vehicle and/or display lane line representations via an interface for a user (e.g., driver).

As used herein, prediction of lane line locations may be understood to refer to determination of probable future (e.g., forward-path, not yet visible) lane line conditions, while inference of lane line locations may be used to refer to determination of probable location of current/present lane line conditions. The same/similar techniques described herein can be used for either or both prediction of lane line locations and/or inference of lane line locations. The terms infer and predict as used herein to refer to things other than lane lines, are used as they would be understood to a person of skill in the art and are not to be understood as being limited based on the framing set out above with respect to prediction and inference of lane line locations.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

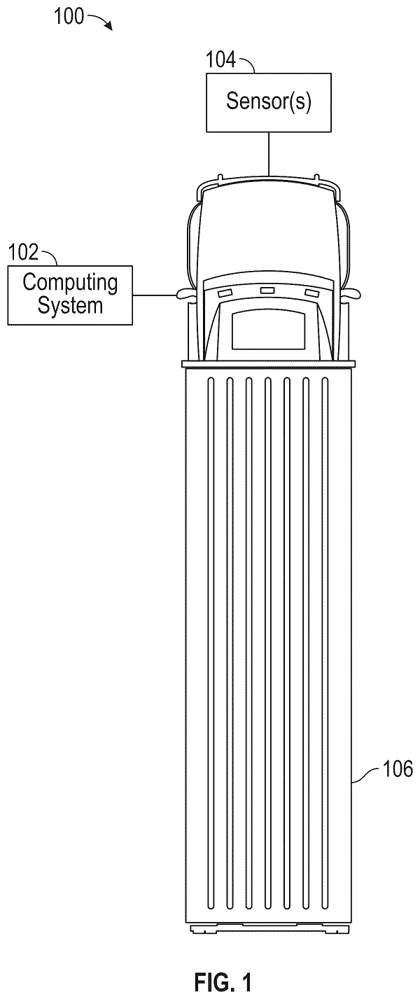

FIG. 1 illustrates an exemplary system 100. System 100 may include a computing system 102 configured to predict the location of one or more lane lines on a roadway. Computing system 102 may be configured to receive data from one or more sensors 104, extract location data points from the image data that are associated with lane lines, model the lane lines as a probabilistic mixture of continuous parametric functions (e.g., one function per lane line), and derive a variational Bayesian inference technique to solve for the posterior probability distribution over the model parameters recursively over time. That is, the computing system 102 may iteratively maximize the variational distribution by updating model hyperparameters to solve for the joint probability distribution over the parameters of the continuous functions conditioned on the image data. Once one or more convergence criteria are satisfied, indicating that the continuous functions provide a satisfactory model of the detected lane lines, the system can predict lane line locations at arbitrary query points using the model (e.g., the system may project the predicted lane line locations ahead of and/or behind the vehicle beyond a range of detected data). That is, the computing system 102 may be configured to determine the corresponding predictive distribution, which predicts the probability density function over the lane line locations at arbitrary query points by marginalizing over the uncertain model parameters in the original probabilistic model. Accordingly, the computing system can be configured to predict lane line locations (y-values) based on new query locations (x-values) using continuous functions determined based on data points extracted from image data.

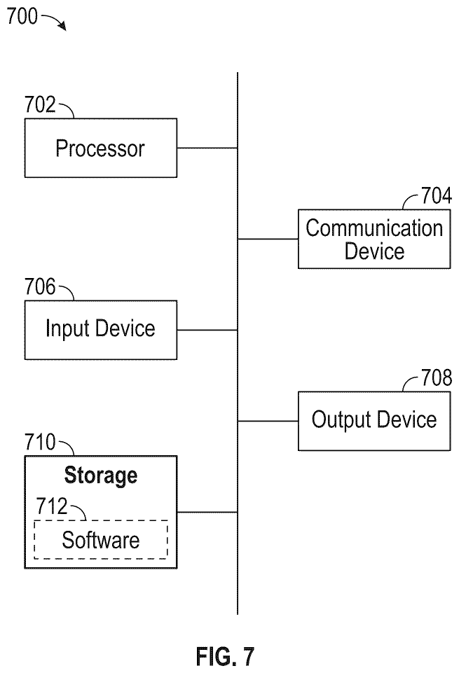

More specifically, the system 100 may detect a first portion of the one or more lane lines using one or more sensors 104 that may include one or more sensors positioned on a vehicle 106 (e.g., about the exterior and/or interior of the vehicle). Sensors 104 may include camera(s), LIDAR sensor(s), radar sensor(s), etc. The portion of the one or more lane lines may be detected using a subset of the sensors (e.g., the camera(s)), while other sensors may be provided for different tasks, such as obstacle detection. The vehicle 106 may be a fully autonomous vehicle, partially autonomous vehicle, human operated vehicle, or may be configured for both autonomous and human operation, and the sensors may collect image data of the vehicle's surroundings on a roadway, which may include at least a portion of one or more lane lines on the roadway. The computing system 102 may receive the image data from sensors 104, for instance, via a communications unit (such as communication device 702 described with reference to FIG. 7) and process the image data to predict lane line locations (e.g., using processors 702, etc.), as described in additional detail below.

Processing the image data may include determining a plurality of location points indicating locations of the one or more lane lines based on the image data. For example, the computing system 102 may overlay a bird's eye view (BEV) grid or point cloud over the image data, and each grid cell or point may be labeled by the system based on a probability that the point or grid cell corresponds to a lane line. The system may assign semantic labels to cells corresponding to lane lines in the BEV grid (e.g., a label may indicate “lane line”). More specifically, the computing system 102 may determine a two-dimensional BEV grid of cells based on the image data and assign at least one semantic label and/or at least one confidence value associated with the at least one semantic label to a plurality of cells of the grid. The system may assign the semantic label and/or confidence value to each cell of the grid. The at least one semantic label and the at least one confidence value may be indicative of whether the cell includes a lane line. For instance, a cell may be assigned a semantic label “lane line” and a corresponding confidence value 85% indicating that the system determined there was an 85% probability that the cell represented image data including a lane line. The system may additionally or alternatively assign semantic labels and confidence values indicative of whether each cell of the plurality of cells does not include a lane line. For example, the same cell may be assigned a label of “not lane line” and a corresponding confidence value of 15%. The computing system 102 may be configured to model the lane lines as continuous functions by determining one or more continuous functions to respectively represent the one or more lane lines based on the plurality of location points.

To determine the continuous functions, computing system 102 may (1) initialize a plurality of hyperparameters, (2) determine a respective probability that each of the location points extracted from the image data corresponds to each of the one or more continuous functions (as noted, these respective probabilities may be referred to herein as responsibilities) based on the hyperparameters (either the initial hyperparameter values during a first iteration or the hyperparameters determined at the maximization step of the previous iteration), otherwise known as a variational expectation step, and (3) update the estimates of the model hyper-parameters for each continuous function to those values that maximize the variational distribution given the expected value of the responsibilities solved for in the variational expectation step, otherwise known as a variational maximization step. Steps (2) and (3) may be iteratively performed until a convergence criteria is satisfied, and, once the convergence criteria is satisfied, the computing system may determine which functions correspond to existing lane lines based on responsibility metrics (which may be determined based on the responsibilities), filter those functions that do not correspond to existing lane lines from the analysis, and predict the distribution over the output of the remaining functions at new inputs (e.g., the lane line locations at new query points). Additional detail is provided on each of the aforementioned steps below.

As noted, the first step in determining the one or more continuous functions may be to initialize the hyperparameter estimates at the current time. The hyperparameters may include the mean (average) of the function parameter estimates at the current time, the covariances encoding uncertainty into the function parameter estimates at that time, and the concentration parameters of the Dirichlet distribution over mixture weights assigned to each function. At an initial time (e.g., prior to receive of the first frame of image data) the hyperparameter values may be initialized by setting the concentration parameters to 1, and by setting the mean of the function parameter estimates and the covariances encoding uncertainty into the function parameter estimates to a reasonable value based on the task (e.g., lane line prediction). The system may leverage prior knowledge/assumptions to initialize the hyperparameters at the initial time. For instance, the system may be configured to assume the vehicle to be centered in a lane (e.g., the center lane, the right-most lane, the left-most lane, etc.), and initialize the hyperparameters such that they represent straight parallel lines, with spacing equal to a typical lane width. However, convergence may be reached even if the hyperparameters are initialized such that the represent overlapping lane lines positioned along the centerline of the vehicle. In other words, the system's performance is relatively insensitive to the initialization. The number of lane lines may be initialized to the maximum number of lane lines present at any location in an operational design domain (ODD).

Alternatively, if a frame of image data has already been processed and posterior hyperparameters estimates already determined, the hyperparameter estimates may be initialized by transforming the posterior hyperparameter estimates at time k−1 to that at time k, for instance, based on the delta pose of the vehicle. In other words, based on the system's knowledge of the change of position and orientation of the vehicle on the roadway, the system may update the hyperparameters and set the updated values as the initial hyperparameters for the next frame of image data.

Once the hyperparameters have been initialized for a respective frame of image data, the computing system 102 may compute a design matrix based on the location data points extracted from the image data collected by sensor(s) 104. The design matrix may represent a set of basis functions evaluated at each input datum. The basis functions may optionally be 2nd order polynomials. However, a variety of additional, or alternative, basis function types may be used. For instance, the basis functions may be third order polynomials, spline functions, clothoid functions, any other type of function capable of being utilized to represent a lane line, etc. Based on the basis functions, computing system 102 may determine the respective probability that each of the location points extracted from the image data corresponds to each of the one or more continuous functions (as used herein, these respective probabilities may be referred to as responsibilities) based on the hyperparameters (either the initial hyperparameter values during a first iteration or the hyperparameters determined at the maximization step of the previous iteration), which, as noted above, is otherwise known as a variational expectation step. The result of the variational expectation step may be an expected value of a permutation matrix (given the probability distribution over the permutation matrix) encoding the responsibility between each data point and the continuous function explaining it. Specifically, while each row and column of a permutation matrix has exactly one entry equal to 1, and the rest of the entries are set to 0, each row and column of the expected value of the permutation matrix resulting from the variational expectation step has entries on the interval [0,1] that sum to 1.0, encoding the probability that cach point corresponds to each continuous function.

Next, the computing system 102 may perform the variational maximization step (M-step) to update the hyper-parameter estimates to those that maximize the variational distribution given the current expectation of the permutation matrix computed in the variational expectation step. That is, the system may update the hyperparameter estimates to those that maximize the variational distribution given the expected value of the responsibilities solved for in the variational expectation step. Intermediate variables used during the variational maximization step may include one or more diagonal matrices formed based on respective columns (e.g., the [symbol] column corresponding to one of L lane lines) computed during the variational expectation step, which may be used to update hyperparameter estimates.

After updating the hyperparameters of the probability distribution over the continuous function parameters at the variational maximization step based on the current expectation of the permutation matrix computed in the variational expectation step, computing system 102 may determine whether a convergence criterion is satisfied prior to predicting lane line locations using the continuous function(s). The computing system 102 may determine that a convergence criterion is not satisfied based on an initial joint probability distribution evaluated at the expected value of the model parameters determined based on the first plurality of hyperparameters and an updated joint distribution evaluated at the expected value of the model parameters of the one or more continuous functions determined based on the updated plurality of hyperparameters.

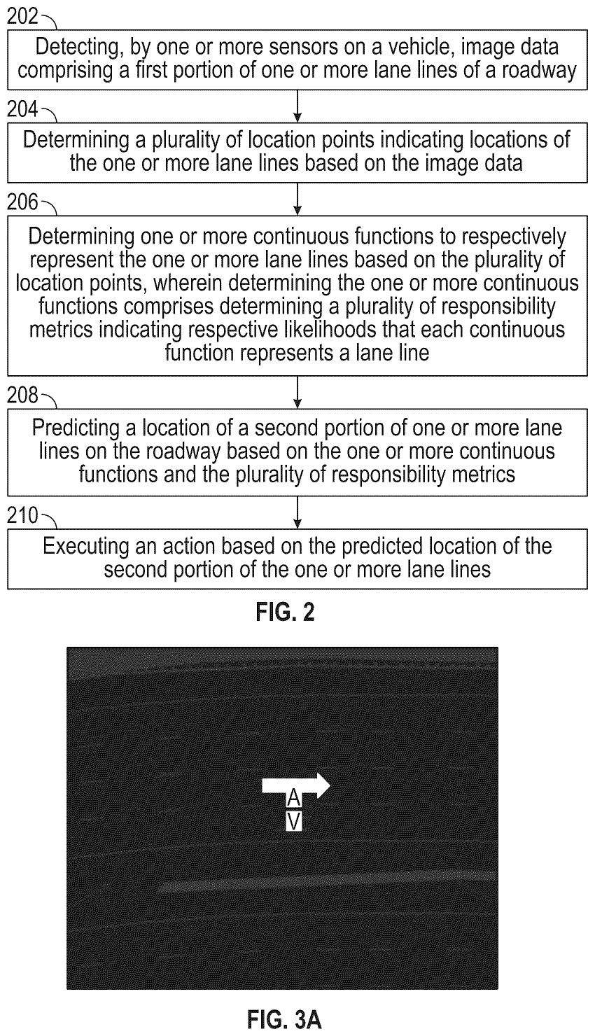

Computing system 102 may determine that the convergence criteria is not satisfied based on a determination that a difference between the updated joint probability distribution and the initial joint probability distribution exceeds a threshold. Thus, in some embodiments, determining whether the convergence criterion is satisfied may include determining whether the joint distribution evaluated at the expected value of the model parameters, including the responsibilities, weights of each function, and function parameters of each function changes by less than a threshold percentage over the current iteration. An exemplary mathematical description of determining whether the convergence criteria is satisfied is provided below with reference to FIG. 2. If the convergence criteria is not satisfied, then the computing system may return to the variational expectation step, initializing the hyperparameter estimates used at the variational expectation step by transforming the posterior hyperparameter estimates at time k−1 to that at time k, as described above, for instance, based on the delta pose of the vehicle. In some examples, the computing system initializes the hyperparameter estimates used at the variational expectation step by transforming the posterior hyperparameter estimates at time k−1 to that at time k only for the first iteration at a new timestep (e.g., after receiving new image data). If the convergence criteria is not satisfied after the first iteration at any one given timestep (e.g., based on the same image data), the subsequent iterations at the same timestep use the hyperparameter estimates from the variational maximation step of the previous iteration in the variational expectation step at the current iteration.

If the convergence criteria is satisfied, then the computing system 102 may determine which functions correspond to existing lane lines based on responsibility metrics (which may be determined based on the responsibilities) and filter those functions that do not correspond to existing lane lines from the analysis. The computing system 102 may be configured to determine functions for a predefined maximum number of lane lines (e.g., 1, 2, 3, 4, 5, 6, 7, 8, 9, 10, etc.). Responsibility metrics may be determined for each of the predefined number of continuous function(s) based a respective probability that each of the location points corresponds to each of the one or more continuous functions. The responsibility metrics may include a mean, median, sum, or some other metric of the responsibilities of each location data point associated with the function. Accordingly, those functions that are more likely to explain location data points associated with lane lines based on the responsibilities may have relatively higher responsibility metrics. The responsibility metrics may essentially act as mixing coefficients, determining the weight that each respective function is assigned in the probabilistic mixture. Those functions assigned relatively lower responsibility metrics may be filtered from the analysis (e.g., by setting the responsibility metrics/weights to zero) because they may be unlikely to represent existing lane lines. Accordingly, determining the one or more continuous functions may include determining that at least one of the one or more continuous functions does not represent a lane line based on the plurality of responsibility metrics and filtering the at least one continuous function from the one or more continuous functions.

After filtering out any continuous functions that are not associated with an existing lane line, the computing system 102 may predict a location of a second portion of one or more lane lines on the roadway. The prediction may be based on the one or more continuous functions and the plurality of responsibility metrics associated with the respective functions, along with other parameters and hyperparameters. That is, the computing system 102 may be configured to predict the distribution over the output of the remaining functions at new inputs. In this way, the computing system may predict the lane line locations at new query points. So, predicting the location of the second portion of the one or more lane lines may include predicting a probability distribution over an output of the one or more continuous functions. Predicting the location of the second portion of the one or more lane lines may include predicting an output based on a function that comprises a two-dimensional curve corresponding to the location of the one or more lane lines along the roadway. The computing system 102 may be configured to predict location(s) of the second portion of the one or more lane lines based on the one or more continuous parametric functions in a region limited to a predefined distance from the vehicle.

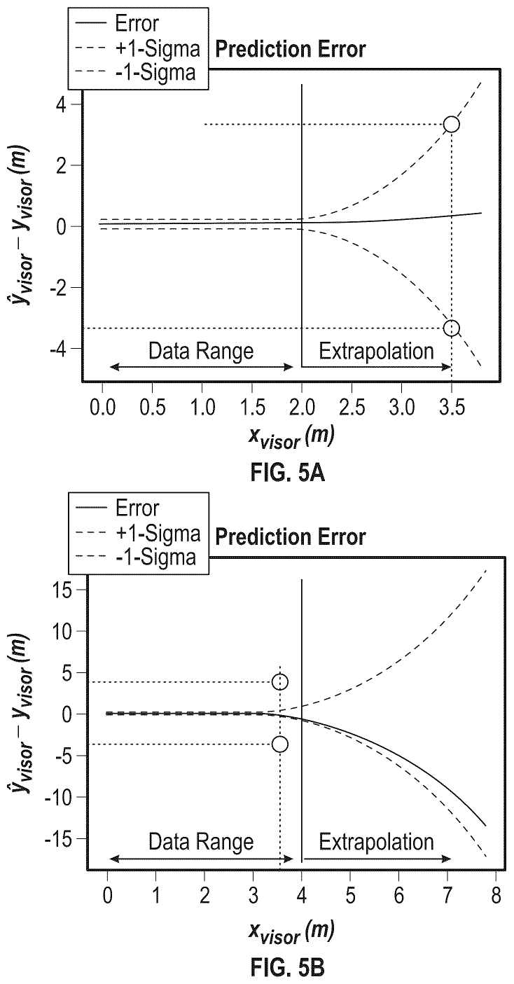

Additionally, or alternatively, the computing system 102 may be configured to predict location(s) of the second portion of the one or more lane lines based on the one or more continuous parametric functions within a predefined valid prediction domain. The valid domain may be defined based on the extreme values of the input data that are maximally explained by cach continuous function, as determined from the responsibilities. Accordingly, the valid domain may be defined as a function of the most extreme (e.g., furthest distance from the vehicle) detected data that is associated with one of the continuous functions based on the responsibilities. In some embodiments, the valid prediction domain may be defined based on a variety of additional, or alternative, conditions, such as the quality of the sensor data, the speed of the vehicle, conditions external to the vehicle such as road conditions, weather conditions, traffic conditions, etc., the stability of the inference/predictions over several iterations, or any combination thereof. In some embodiments, the valid prediction domain may be dynamically updated based on one or more of the aforementioned conditions. As an example of how the valid prediction domain may be configured, in some embodiments, the confidence of the prediction (e.g., the predicted distribution over the output of the functions at new inputs) may be bounded. For instance, the output of the predictive distribution evaluation may be a mean and variance over the lane line locations, where that variance encodes the error bounds on the estimate (e.g., the system may be 68% confident that the true lane line location is within +/− one standard deviation of the mean estimate). Accordingly, the valid domain may be defined as that under which the model is sufficiently confident in its prediction (e.g., its predicted variance is less than a threshold). The computing system 102 may be configured to predict the location of the second portion of the one or more lane lines by predicting a location envelope of the one or more lane lines based on an error function, for instance, as illustrated in FIGS. 5A and 5B below.

Computing system 102 may be configured to predict the location of the second portion of the one or more lane lines in a region out of range of the one or more sensors 104. For instance, the one or more sensors 104 may be configured with a range of 30 meters, and computing system 104 may be configured to predict lane line locations out to at least 50 meters. It should be understood that the aforementioned sensor range and prediction range are meant only to be exemplary and not limiting. Any possible sensor and prediction ranges are within the scope of this disclosure.

Computing system 102 may also be configured to execute various actions based on the predicted lane line locations. Computing system 102 may control an autonomous vehicle based on the predicted location of the second portion of the one or more lane lines. For example, the system may execute a lane change maneuver, cause the vehicle to maintain or modify its within a lane, cause the vehicle to increase or decrease its speed, etc. The system may additionally or alternatively display the predicted location of the second portion of the one or more lane lines on a user interface of a vehicle. The interface may enable a user to view a synthetic representation of the roadway, including the predicted lane line locations as well as detected objects, the relative locations between the objects and the vehicle or the lane lines, and so on.

Finally, after predicting the location of the second portion of the one or more lane lines based on a frame of detected image data, the system may receive a second frame of image data and repeat the process described above, extracting data, determining continuous functions to represent the data, and predicting lane line locations. Accordingly, the lane line prediction process described herein may be iterative in each frame. However, each iteration is inexpensive, and the recursion over time may allow for a very good prior estimate derived from the posterior at the previous time step, which should enable very fast convergence. In some embodiments, only the latest estimate of the hyperparameters (which may be determined according to exemplary equations 2.1, 2.2, and 2.3 below) are carried over from frame to frame.

Below, the lane line prediction process described with reference to system 100 is described in additional detail with corresponding exemplary mathematical notation that may be utilized to implement the method according to some embodiments. FIG. 2 illustrates an exemplary process 200 for inferring and/or predicting lane line locations, according to some embodiments. Process 200 is performed, for example, using one or more electronic devices implementing a software platform. In some examples, process 200 is performed using one or more electronic devices. In some embodiments, process 200 is performed using a client-server system, and the blocks of process 200 are divided up in any manner between the server and one or more client devices. Thus, while portions of process 200 are described herein as being performed by particular devices, it will be appreciated that process 200 is not so limited. In process 200, some blocks are, optionally, combined, the order of some blocks is, optionally, changed, and some blocks are, optionally, omitted. In some examples, additional steps may be performed in combination with the process 200. Accordingly, the operations as illustrated (and described in greater detail below) are exemplary by nature and, as such, should not be viewed as limiting. Moreover, while specific equations are included in the description of FIG. 2, it should be understood that these are only meant to be exemplary. Different equations may be used in carrying out the method, for instance, if a different type of function (e.g., a clothoid) is utilized in place of a polynomial.

At block 202, an exemplary system (e.g., one or more electronic devices including, for instance, system 100 described above) detects image data that includes at least a first portion of one or more lane lines on a roadway. The system may detect the first portion of the one or more lane lines using one or more sensors positioned on a vehicle (e.g., about the exterior and/or interior of the vehicle), and may include camera(s), LIDAR sensor(s), radar sensor(s), etc. The portion of the one or more lane lines may be detected using a subset of the sensors (e.g., the camera(s)), while other sensors may be provided for different tasks, such as obstacle detection. One skilled in the art would understand that additional hardware and/or software may be provided on an exemplary system to enable the one or more sensors to obtain the image data, for instance, cameras may be mounted to the vehicle at strategic locations using various protective casings and connected to processing units using wiring, etc.

At block 204, the system may determine a plurality of location points indicating locations of the one or more lane lines based on the image data. Determining the location points indicating locations of the one or more lane lines may include assigning semantic labels to cells corresponding to lane lines in a bird's eye view (BEV) grid. More specifically, the system may determine a two-dimensional BEV grid of cells based on the image data and assign at least one semantic label and/or at least one confidence value associated with the at least one semantic label to a plurality of cells of the grid. The system may assign the semantic label and/or confidence value to each cell of the grid. The at least one semantic label and the at least one confidence value may be indicative of whether the cell includes a lane line. For instance, a cell may be assigned a semantic label “lane line” and a corresponding confidence value 85% indicating that the system determined there was an 85% probability that the cell represented image data including a lane line. The system may additionally or alternatively assign semantic labels and confidence values indicative of whether each cell of the plurality of cells does not include a lane line. For example, the same cell may be assigned a label of “not lane line” and a corresponding confidence value of 15%.

The semantic labels and corresponding confidence values may be assigned by a trained classifier model, for instance, a convolutional neural network model or other computer vision model trained to classify the cells of the BEV grid according to whether the cells respectively include (e.g., depict/represent) lane lines. The classifier model may be trained using labeled image data. The classifier model may have been trained using image data that does not include images depicting lane lines on a roadway and retrained using labeled image data that includes images depicting lane lies on a roadway. The semantic labels and corresponding confidence values may additionally or alternatively be assigned by a human operator.

After assignment of the semantic labels and/or confidence values, the system may extract a location point (e.g., a centroid) from each cell that is assigned a semantic label indicating that the cell includes a lane line and/or a confidence value exceeding a threshold. For instance, if a cell is assigned a label of “lane line” the system may extract the centroid of the cell, which may subsequently form at least a portion of an input to a model configured to predict locations of the corresponding lane line on a roadway. The system may additionally or alternatively extract the centroid of cells that are both assigned a label of “lane line” and a confidence value associated with the label of at least a threshold value, such as at least 50%, at least 60%, at least 70%, at least 80%, at least 90%, at least 95%, or any other threshold value. The threshold value(s) that may serve as the cutoff for which cells are selected for centroid extraction may be a predefined value set by a user of the system. The goal of this step may be to collect a set of two-dimensional data points from the BEV grid to be used to fit the model. These points may be modeled as: [symbol] ₙ( [symbol] )˜ [symbol] ( [symbol] ₙ, [symbol] ) where { [symbol] , [symbol] ₙ} is the centroid of the n^{th} BEV grid cell with sufficiently confident lane line label, and

$${σ}_{y}^{2} = \frac{1}{4} {δ}^{2} ,$$

where δ is the BEV grid cell size. In this way, the [symbol] (one standard deviation) envelope for a given data point is inscribed within the corresponding BEV grid cell to roughly model the discretization error imposed by the grid.

Based on the extracted location points indicating the location of the one or more lane lines, the system may determine a design matrix [symbol] ( [symbol] ), which may be an N×M matrix comprising the set of basis functions evaluated at each input datum, where N corresponds to the number of data points (location points) and M corresponds to the number of basis functions per continuous function. The basis functions may be represented herein as Φ( [symbol] )={ϕ₁( [symbol] ), . . . , ϕ_{M}( [symbol] )}, which includes a fixed set of basis functions evaluated at a single input datum, x, and the design matrix Φ( [symbol] ) can be represented as:

$$Φ ( 𝒳 ) = [ \begin{matrix}{ϕ}_{1} ( {x}_{1} ) & … & {ϕ}_{M} ( {x}_{1} ) \\ ⋮ & ⋱ & ⋮ \\ {ϕ}_{1} ( {x}_{N} ) & … & {ϕ}_{M} ( {x}_{N} )\end{matrix} ]$$

The design matrix may be set of basis functions evaluated at each input datum x₁ to xₙ, where N corresponds to the number of data points and M corresponds to the number of basis functions per continuous function. As noted above, the basis functions may be polynomial functions (e.g., 1^{st} order, 2^{nd} order, 3^{rd} order, etc.), spline functions, clothoid functions, and so on. One skilled in the art would understand that the basis functions may be any function that can serve to represent the geometry of a lane line.

At block 206, the system may determine one or more continuous functions to respectively represent the one or more lane lines based on the plurality of location points. That is, the system may receive as an input a two-dimensional BEV grid with semantic labels and/or confidence values, extract location points from at least a subset of cells of the grid associated with desired semantic labels and/or confidence values (e.g., those associated with lane lines) and determine continuous function(s) based on the location points, where the continuous functions include a combination of the basis functions described above. The continuous functions may be constrained to a linear combination of the basis functions. That is, the functions may be written as a linear combination of fixed, (potentially) nonlinear functions (e.g., basis functions) of input variables. In this way, the functions may be linear in their parameters to facilitate efficient inference but remain nonlinear functions of the input variables to retain the expressive power of the model. The functions may be configured to map arbitrary query point(s) (e.g., an x-coordinate) to a probability distribution over the predicted y-coordinates of all lane lines at that x-coordinate. The one or more continuous functions may include continuous parametric functions. In some embodiments, the one or more continuous parametric functions may include polynomial functions, clothoid functions, spline functions, and/or any other function capable of being utilized to represent a lane line.

Determining the one or more continuous functions may include determining a plurality of parameters, hyperparameters, and responsibility metrics indicating respective likelihoods that each continuous function represents an existing lane line (e.g., as opposed to some other marking on a roadway). The function parameters, which may be represented as [symbol] ={m₁, . . . , m_{L}} and the responsibility metrics, which may correspond to weights or mixing coefficients represented as [symbol] ={w₁, . . . , w_{L}} of each continuous function in a probabilistic mixture of continuous functions where each function represents a lane line, may be determined based on iteratively updated hyperparameters of each function according to a variational expectation and variational maximization process outlined above with reference to FIG. 1 and described in additional detail with corresponding exemplary mathematical notation below. In some embodiments, the joint distribution can be represented as follows.

$$p ( 𝒴 ( 𝒳 ) , , , ) = p ( 𝒴 ( 𝒳 ) \vert , ) p ( \vert ) p ( ) p ( ) \qquad ( 0.1 )$$

Equation (0.1) above represents a joint distribution that can be tracked over time by tracking hyperparameters of the distribution, μ, S, and α, as described in additional detail below. Each y represents a function mapping inputs to multimodal outputs, where each of {y₁, . . . , yₙ} represents one of n lane lines and x={x₁, . . . , xₙ} and represents inputs/query points that may correspond to arbitrary x-coordinates input into the probabilistic mixture of continuous functions to determine corresponding y-coordinates of all lane lines (each represented by a corresponding function), as described in further detail below. [symbol] as used in equation (0.1) may represent an N×L permutation matrix encoding the latent 1 of L correspondence between each data point n and the function L explaining the respective data point, which, as discussed, may be referred to herein as a “responsibility,” or a probability that a respective data point corresponds to a given function. In other words, [symbol] (n, [symbol] )=1 indicates that the n^{th} data point is explained by the [symbol] continuous function.

Each function in the probabilistic mixture may include a plurality of latent parameters and hyperparameters. As noted above, the function parameters for each continuous function may be represented as [symbol] ={m₁, . . . , m_{L}} where [symbol] ˜ [symbol] (μ, S), meaning [symbol] is distributed normally with μ and S. The hyperparameters may be represented as μ={μ₁, . . . , μ_{L}}, where μ is the mean of the function parameter estimates for each continuous function L, S={S₁, . . . , S_{L}}, where S represents the covariance encoding uncertainty in the function parameter estimates for each function L, and α={α₁, . . . , α_{L}}, where α represents concentration parameters of the Dirichlet distribution over mixture weights, [symbol] for each function L. For tractable recursion over time, the conditional distributions on the right-hand side of (0.1) should be self-conjugate; thus, they may be defined as:

$$p ( 𝒴 ( 𝒳 ) \vert , ) = {\prod }_{n = 1}^{N} {\prod }_{ℓ = 1}^{L} {𝒩 ( {y}_{n} ( {x}_{n} ) \vert Φ ( {x}_{n} ) \cdot {m}_{ℓ} , {σ}_{y , n}^{2} )}^{( n , ℓ )} \qquad ( 0.2 )$$

$$p ( \vert ) = {\prod }_{n = 1}^{N} {\prod }_{ℓ = 1}^{L} {w}_{ℓ}^{( n , ℓ )} \qquad ( 0.3 )$$

$$\begin{matrix}p ( ) = Dir ( \vert α ) \\ = C ( α ) {\prod }_{ℓ = 1}^{L} {w}_{ℓ}^{{α}_{k} - 1}\end{matrix} \qquad ( 0.4 )$$

$$p ( ) = {\prod }_{ℓ = 1}^{L} 𝒩 ( {m}_{ℓ} \vert {μ}_{ℓ} , {S}_{ℓ} ) \qquad ( 0.5 )$$

Accordingly, to track the joint distribution in (0.1) over time, the system may track (e.g., iteratively update the hyperparameter estimates to maximize the variational distribution) hyperparameter estimates μ, S, and α. As used in (0.2) above, [symbol] may correspond to noise variance in the labeled outputs and may be assumed to be stationary.

The system may determine a first plurality of hyperparameters for the one or more continuous functions at a first time, k, which may be before, in parallel to, or after detection of the image data. For instance, at an initial time (prior to detection of image data) when k=k₀: parameters μ=μ₀, S=S₀, α=α₀, and k=k₀. Conceptually, α may roughly correspond to the number of data points and may be initialized at k₀ it to its minimum value of 1 for each continuous function in cases where there is no prior knowledge. Similarly, μ and S may be initialized to reasonable values based on the task, for instance, to reflect equally spaced lines perpendicular to a vehicle, with 1−σ (e.g., one standard deviation) bound equal to half of the line spacing. Further, a priori knowledge of lane geometry statistics (e.g., based on NHTSA rules about lane geometry) may be used as prior knowledge in initializing the model hyper-parameter estimates. As described above with reference to FIG. 1, various other initializations are possible.

If k≠k₀ (e.g., if k>k₀, which may mean that the system has acquired and processed at least one frame of image data) then the system may transform the posterior hyperparameter estimates μ, S, and α, at time k−1 to that at time k. In other words, the system may initialize hyperparameter estimates in the current frame (e.g., of image data) based on the hyperparameter estimates in the previous frame. The lane lines may be static with respect to a global reference frame, but the model may be inferred in a reference frame fixed to a vehicle on which the sensors capturing the image data are mounted. Therefore, the correct model parameters can change with vehicle motion in a predictable way, which can be computed in closed-form given the delta pose of the vehicle (as used herein, the delta pose of the vehicle may refer to the change in the position and the orientation of the vehicle).

The transformation of μ may be approximated over a time horizon (e.g., a predefined time horizon), and the uncertainty terms, S and α, may be dithered by some amount to account for error in the approximation (optimal perturbations may be learned, tuned from data, or even worked out in closed form depending on the nature of the approximation). The algorithm may be configured to maximize the variational distribution in each frame, so any reasonable initialization of hyperparameters may converge to a similar result; although a more accurate initialization may converge faster and more reliably. The system may be configured to assume μ is roughly unchanged over a single time step (e.g., from frame to frame of image data). Alternatively, the system may approximate vehicle motion as pure translation along its x-direction, such that the function is just shifted: f( [symbol] )≈f( [symbol] +υₖ₋₁·Δt_{k-1,k}) at the next frame of image data; the coefficients of the shifted polynomial can be computed with the Tayler Shift. As an example, the functions and their distributions may be defined from the perspective of the vehicle. So, as the vehicle moves between two time steps (e.g., between two image frames) the functions may be transformed from the coordinate from associated with one time step to the next. Over a relatively small time step (e.g., 100 milliseconds) the vehicle motion can be approximated as moving forward or backward along its x-coordinate axis (e.g., it's longitudinal axis), which may be the independent variable of the continuous functions described herein. So, this projection between the two coordinate frames amounts to shifting the independent variable of the function by the displacement of the vehicle over that time step. For example, if the vehicle moves forward d meters, we have: g(y)=f(x+d), where g(y) is the new function at time k+1, and f(x+d) is the old function at time k (y was used here instead of x to highlight the fact that g( ) is defined in a different coordinate system, where the relationship is y=x+d. Since the exemplary function used here is a polynomial and a polynomial is defined by its coefficients, the goal is to find the coefficients that describe the shifted polynomial. More specifically, we are actually looking for the set of hyperparameters that describe distribution over the coefficients of the shifted polynomial. These hyperparameters ideally would describe a distribution that is shifted in space by the vehicle displacement, and also increased entropy/variance to capture any error incurred by the approximation of the vehicle motion.

Because S is a covariance matrix, increasing the uncertainty in the locations of the lane lines may be accomplished by adding a symmetric positive semi-definite matrix to S (e.g., adding the covariance of the approximation error). Similarly, adding uncertainty in the number of lane lines and their responsibilities can be achieved by subtracting a positive scalar value from α. Specifically, the variance of a Dirichlet distributed random variable is defined as:

$${σ}_{w , ℓ}^{2} = \frac{{\overline{α}}_{ℓ} ( 1 - {\overline{α}}_{ℓ} )}{{\sum }_{ℓ = 1}^{L} {α}_{ℓ} + 1}$$

$${\overline{α}}_{ℓ} = \frac{{α}_{ℓ}}{{\sum }_{ℓ = 1}^{L} {α}_{ℓ}}$$

Accordingly, to summarize, the hyperparameter estimates μ, S, and α, may be initialized by setting α to 1, and by setting μ, and S to a reasonable value based on the task (e.g., lane line prediction) where k=k₀. When k≠k₀, the hyperparameter estimates may be initialized by transforming the posterior hyperparameter estimates μ, S, and α, at time k−1 to that at time k. For instance, the hyperparameters determined at k₀ may be transformed to obtain an initial estimate of the hyperparameters at time k, for instance, based on the delta pose of the vehicle.

Based on the most up to date hyperparameter estimates during processing of each frame of image data (e.g., the initialized estimates described above, or updated estimates that may be determined iteratively during processing of each image data frame until a convergence criteria is satisfied as described in further detail below), the system may determine a respective probability that each of the location points corresponds to each of the one or more continuous functions. As noted above, the probabilities may be referred to herein as responsibilities, and determination of the responsibilities may be referred to herein as the variational expectation step. Determining the respective probability that each of the location points corresponds to each of the one or more continuous functions based on the hyperparameter estimates may include determining the expected value of the N×L permutation matrix, Z, encoding the latent 1 of L correspondence between each data point and the continuous function explaining it, where N corresponds to the number of data points (e.g., location points) and L corresponds to the number of continuous functions. The expected value of permutation matrix, E[Z], may be determined as follows.

$$[ ( n , ℓ ) ] = \frac{ρ ( n , ℓ )}{{\sum }_{ℓ = 1}^{L} ρ ( n , ℓ )} \qquad ( 1.1 )$$

### Where:

$$ln [ ρ ( n , ℓ ) ] = Γ ( {α}_{ℓ}^{*} ) - Γ ( {\sum }_{ℓ = 1}^{L} {α}_{ℓ}^{*} ) - {\frac{1}{2 {σ}_{y}^{2}} [ {y}_{n} ( {x}_{n} ) - Φ ( {x}_{n} ) {μ}_{ℓ}^{*} ]}^{2} - \frac{1}{2} ln ( 2 {πσ}_{y}^{2} ) \qquad ( 1.2 )$$

Where Γ(⋅) is the Digamma function. The sum in the denominator of (1.1) may be computed via the log-sum-exp trick to avoid issues with numerical underflow that can occur when the log in (1.2) is large negative numbers for all continuous functions, [symbol] , such that the exponential is truncated to zero.

As noted above, the system may determine an updated plurality of hyperparameters at a second time (k) after the first time (e.g., k₀) based on the respective probability that each of the location points corresponds to each of the one or more continuous functions based on the first plurality of hyperparameters. Updating the hyperparameters may be referred to herein as the variational maximization step. The updated plurality of hyperparameters may be determined at a second time (e.g., second iterative step) while still processing a single frame of image data, and this may be repeated until a convergence criterion is satisfied. The updated plurality of hyperparameters for each continuous function may be set to values that maximize the variational distribution given the expected value of the responsibilities (e.g., the probability that each of the location points corresponds to each of the one or more continuous functions). For instance, hyperparameters may be initialized at k₀. Those initial hyperparameters may be recursively updated based on the respective probability that each of the location points corresponds to each of the one or more continuous functions by iteratively, during the processing of each image data frame, setting the hyperparameters values to maximize the variational distribution given the expected value of the responsibilities. The updated plurality of hyperparameters may be determined according to the following equations.

$${α}_{ℓ}^{*} = {α}_{ℓ , 0} + {\sum }_{n = 1}^{N} [ ( n , ℓ ) ] \qquad ( 2.1 )$$

$${μ}_{ℓ}^{*} = {S}_{ℓ}^{*} ( {S}_{ℓ , 0}^{- 1} {μ}_{ℓ , 0} + \frac{1}{{σ}_{y}^{2}} {Φ ( 𝒳 )}^{T} {R}_{ℓ}^{*} 𝒴 ( 𝒳 ) ) \qquad ( 2.2 )$$

$${S}_{ℓ}^{*} = {[ {S}_{ℓ , 0}^{- 1} + \frac{1}{{σ}_{y}^{2}} {Φ}^{T} ( 𝒳 ) {R}_{ℓ}^{*} Φ ( 𝒳 ) ]}^{- 1} \qquad ( 2.3 )$$

### Where:

$${R}_{ℓ}^{*} = diag \{ [ ( : , ℓ ) ] \} \qquad ( 2.4 )$$

where [symbol] =diag{ [symbol] [ [symbol] (:, [symbol] ]} is an N×N diagonal matrix formed from the [symbol] column of [symbol] [ [symbol] ] computed in the variational E-step via (1.1). Subscripts of 0 may indicate the prior belief of the adorned variable from iteration 0 of the current time step, not the latest iteration.

After determining the updated plurality of hyperparameters, the system may determine whether a convergence criterion is satisfied. An inferred posterior probability distribution over the parameters of the one or more continuous functions will be considered converged if the joint distribution in (0.1) above evaluated at the expected value of the model parameters, [symbol] , [symbol] , [symbol] , changes by less than τ % (e.g., a threshold percentage) over the current iteration.

The expected value of [symbol] may be obtained using (1.1) above, and the others may be obtained as:

$$[ {w}_{ℓ} ] = \frac{{α}_{ℓ}}{{\sum }_{ℓ = 1}^{L} {α}_{ℓ}} \qquad ( 3.1 )$$

$$and$$

$$[ ] = μ \qquad ( 3.2 )$$

If the system determines that the inferred posterior probability distribution over the parameters of the one or more continuous functions is not converged, then the system may replace the initialized hyperparameters with the updated plurality of hyperparameters and determine an updated probability distribution based on the plurality of updated hyperparameters. If sufficient convergence is not achieved within a specified iteration limit, the latest estimate may be reported downstream along with an error indicating the issue with convergence (e.g., the system may acquire a new frame of image data and restart the process initializing the hyperparameters from scratch as described above). If sufficient convergence is achieved, then the system can predict lane line locations at arbitrary query points using the continuous functions, as described further below.

Determining the one or more continuous functions to respectively represent the one or more lane lines based on the plurality of location points may include determining a plurality of responsibility metrics indicating respective likelihoods that each continuous function represents a lane line. That is, the system may be configured to estimate the number of true lane lines present. As noted above L represents the total number of continuous functions, which corresponds to maximum number of lane lines at any location in the operational design domain (ODD). L may be a predefined number provided to the system (e.g., by a user configuring the system). However, there may be fewer lane lines present on the roadway than defined by L. Accordingly, the system may be configured to determine one or more continuous functions for at least a subset of a predefined maximum number of lane lines (e.g., one function per each of the predefined maximum number of lane lines). For instance, the system may be configured to determine 10 total continuous functions that may corresponds to lane lines based on the detected image data. The system may then be configured to determine which of those 10, whether it be 1, 2, 5, 7, etc., actually correspond to an existing lane line on the roadway. To do so, the system may be configured to determine responsibility metrics (e.g., the mixture weights [symbol] described above) indicating respective likelihoods that each continuous function of L represents a lane line, and filter continuous functions having relatively low responsibility metrics from the analysis by setting the respective responsibility metric to zero. The responsibility metrics may be proportional to the relative responsibility each continuous function has in explaining the data. In other words, the responsibility metrics corresponding to each of the one or more continuous functions may be determined based on the probability that each of the location points corresponds to the respective continuous function (e.g., based on a sum, average, etc. of the responsibilities or other metric associated with the responsibilities). Therefore, it follows that continuous functions with negligible mixture weight are not well-determined by the data, and thus are unlikely to correspond to actual lane lanes. Accordingly, the system may select only the L_{effective} continuous functions (e.g., a subset of L) with the highest weight, where L_{effective} is defined as follows:

$$\begin{matrix}{L}_{effective} = \frac{{( {\sum }_{ℓ = 1}^{L} {\overline{w}}_{ℓ} )}^{2}}{{\sum }_{ℓ = 1}^{L} {\overline{w}}_{ℓ}^{2}} \\ = \frac{1}{{\sum }_{ℓ = 1}^{L} {\overline{w}}_{ℓ}^{2}}\end{matrix} \qquad ( 4.1 )$$

Where [symbol] is the expected value of the [symbol] continuous function weight, given as:

$${\overline{w}}_{ℓ} = \frac{{α}_{ℓ}}{{\sum }_{l = 1}^{L} {α}_{l}} \qquad ( 4.2 )$$

As an alternative to the determining the effective number of continuous functions using the exemplary equations above, the system may be configured to consider the responsibilities directly and define a metric based on number and spatial distribution of points maximally explained by each continuous function to inform decisions on which continuous functions to include in the predictive distribution. For instance, the responsibility metric may be a threshold set based on the estimated covariances given that the covariances are a function of the responsibilities (covariances shrink with more data responsibility and broader data domain). Accordingly, the system may be configured to filter out those continuous functions associated with a covariance above a threshold. The threshold may be predefined (e.g., by a user of the system) or the system may be configured to dynamically set the threshold value based on covariance values determined to be more likely associated with existing lane lines.

At block 208, the system may predict a location of a second portion of one or more lane lines on the roadway based on the one or more continuous functions and the plurality of responsibility metrics. That is, at block 208, the system may predict a location of a second portion of one or more lane lines on the roadway based on the one or more continuous functions that were not filtered from the analysis based on the plurality of responsibility metrics. Accordingly, while blocks 202-206 involved collecting data and inferring the probability distribution over the parameters of one or more functions to predict lane line locations. At block 208, the system may predict the location of at least a second portion of the one or more lane lines by predicting a probability distribution over an output of the one or more continuous functions at different inputs. In other words, at block 208, the system may predict lane line locations at new query points. Predicting the location of the second portion of the one or more lane lines may include predicting an output based on a function that comprises a two-dimensional curve corresponding to the location of the one or more lane lines along the roadway. The system may be configured to predict a location of at least one lane line in a region out of range of one or more of the sensors. The prediction may be obtained as described below following the filtering of functions determined not to be associated with lane lines from the analysis.

Once the set of continuous functions has been selected from the total number of continuous functions (e.g., once the functions most likely to be associated with existing lane lines have been selected, for instance, according to equations 4.1 and 4.2 set forth above), the predictive distribution may be defined as:

$${𝒴}^{′} ( {𝒳}^{′} ) = ( {\overline{𝒴}}^{′} ( {𝒳}^{′} ) , \sum ) \qquad ( 4.4 )$$

Where [symbol] is the set of N′ new query points, and the mean is defined as:

$${\overline{𝒴}}^{′} ( {𝒳}^{′} ) = Φ ( {𝒳}^{′} ) \qquad ( 4.5 )$$

Where [symbol] is the subset of L_{effective} elements of [symbol] chosen for the predictive distribution, and the joint covariance of all points predicted from the [symbol] continuous function is defined as:

$${\sum }_{ℓ} = {σ}_{y}^{2} {I}_{{N}^{′}} + Φ ( {𝒳}^{′} ) {S}_{ℓ} {Φ}^{T} ( {𝒳}^{′} ) \qquad ( 4.6 )$$

In some embodiments, the predicted location of the second portion of the one or more lane lines based on the one or more continuous parametric functions is limited to a predefined distance (e.g., a predefined valid domain) from the vehicle. The valid domain of each continuous function may be defined in order to avoid extrapolation beyond the true beginning or end of the lane line, and to limit egregious errors in predictions extrapolated too far outside of the data. The valid domain may be defined from the extreme values of the input data that are maximally explained by each continuous function, as determined from the responsibilities computed in (1.1). Accordingly, the valid domain may be defined as a function of the most extreme (e.g., furthest distance from the vehicle) detected data that is associated with one of the continuous functions based on the responsibilities. In some embodiments, the valid prediction domain may be defined based on a variety of additional, or alternative, conditions, such as the quality of the sensor data, the speed of the vehicle, conditions external to the vehicle such as road conditions, weather conditions, traffic conditions, etc., the stability of the inference/predictions over several iterations, or any combination thereof. In some embodiments, the valid prediction domain may be dynamically updated based on one or more of the aforementioned conditions. As an example of how the valid prediction domain may be configured, in some embodiments, the confidence of the prediction (e.g., the predicted distribution over the output of the functions at new inputs) may be bounded. For instance, the output of the predictive distribution evaluation may be a mean and variance over the lane line locations, where that variance encodes the error bounds on the estimate (e.g., the system may be 68% confident that the true lane line location is within +/− one standard deviation of the mean estimate). Accordingly, the valid domain may be defined as that under which the model is sufficiently confident in its prediction (e.g., when its predicted variance is less than a threshold). In some embodiments, predicting the location of the one or more lane lines may include predicting a location envelope of the one or more lane lines based on an error function, as illustrated in FIGS. 5A and 5B below.

At block 210, the system may execute an action based on the predicted location of the second portion of the one or more lane lines. The system may control an autonomous vehicle based on the predicted location of the second portion of the one or more lane lines. For example, the system may execute a lane change maneuver, cause the vehicle to maintain or modify its within a lane, cause the vehicle to increase or decrease its speed, etc. The system may additionally or alternatively display the predicted location of the second portion of the one or more lane lines on a user interface of a vehicle. The interface may enable a user to view a synthetic representation of the roadway, including the predicted lane line locations as well as detected objects, the relative locations between the objects and the vehicle or the lane lines, and so on.

### EXAMPLES

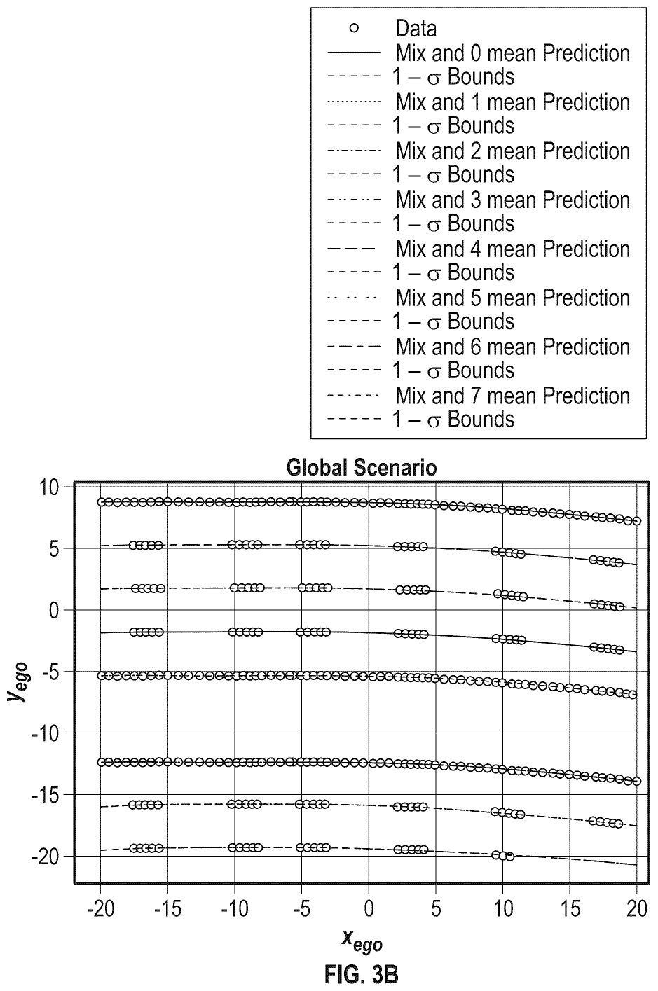

FIGS. 3A and 3B illustrate an example mixture of continuous polynomial functions fit to a single frame of noiseless data. More specifically, FIGS. 3A and 3B illustrate simulation of the algorithm described above with test data using CARLA, an open-source autonomous driving simulator, to serve as a proof of concept for the algorithm. Ground truth semantic segmentation was generated for images taken from a camera pointing straight down at the ground (emulating the BEV described above). The camera used a 1280×1280 pixel resolution, 90 degree field of view in each direction, and was placed 20 m above the ground plane. This corresponds to a 40 m×40 m BEV grid, with 3.125 cm cell size. The algorithm was initialized with the following hyperparameter values ∀ [symbol] ∈{1, . . . , L}:

$${μ}_{ℓ , 0} = {[ {c}_{ℓ , 0} , 0 , 0 ]}^{T} , where {c}_{ℓ , 0} = 20 ( \frac{2 \cdot ℓ}{L + 1} - 1 )$$

$${S}_{ℓ , 0} = {I}_{3}$$

$${α}_{ℓ , 0} = 1$$

$$L = 10$$

where S is represents the covariance, μ represents the mean of the function parameters, α represents the concentration parameters of the Dirichlet distribution over mixture weights, and L represents the total number of continuous functions, as described above. As used above, [symbol] denotes the index of the continuous function (e.g., L functions indexed 1, 2, 3, . . . L). The 0 subscript denotes the iteration (i.e. iteration 0 for the initialization). μ denotes the set of polynomial coefficients in order of increasing exponent [zeroth order, first order, second order]. In other words a polynomial of the form: f(x)=c+b* +a*x\hat{ }2 has coefficients of: μ=[c, b, a]. So, c is the zeroth order coefficient (also known as the “y-intercept”). For this initialization parallel straight lines were assumed, so b=a=0, and c is spaced equally over the y-interval (−20, 20) to space the lane lines in the AV lateral direction.

FIG. 3A illustrates “raw” CARLA semantic segmentation image with the approximate vehicle pose indicated by the blue arrow (the semantic labels are hard to distinguish from the coloring in this image, but the lane lines are apparent). FIG. 3B illustrates the data extracted from the CARLA image (e.g., at block 204 described above) as circles. FIG. 3B also illustrates the means and the +/−1-sigma bounds of the predictive distribution generated based on the continuous functions for each lane line as indicated in the key, e.g., at block 208 described above, computed over a uniform grid of x-values on the interval (−20, 20), respectively. In FIG. 3B, the vehicle (e.g., an autonomous vehicle) is located at the origin and facing to the right. As shown in FIG. 3B, the system correctly identified the number of lane lines included in the image data of FIG. 3A as 8 lane lines in each frame (5 dashed, 3 solid as shown in FIG. 3A), and the predicted lane lines fit the data well, qualitatively. The 1-sigma bounds are on the order of a few centimeters in this example, which is negligible compared to the y-axis scale. The fully synthetic example described below provides a better demonstration of the predictive covariances.

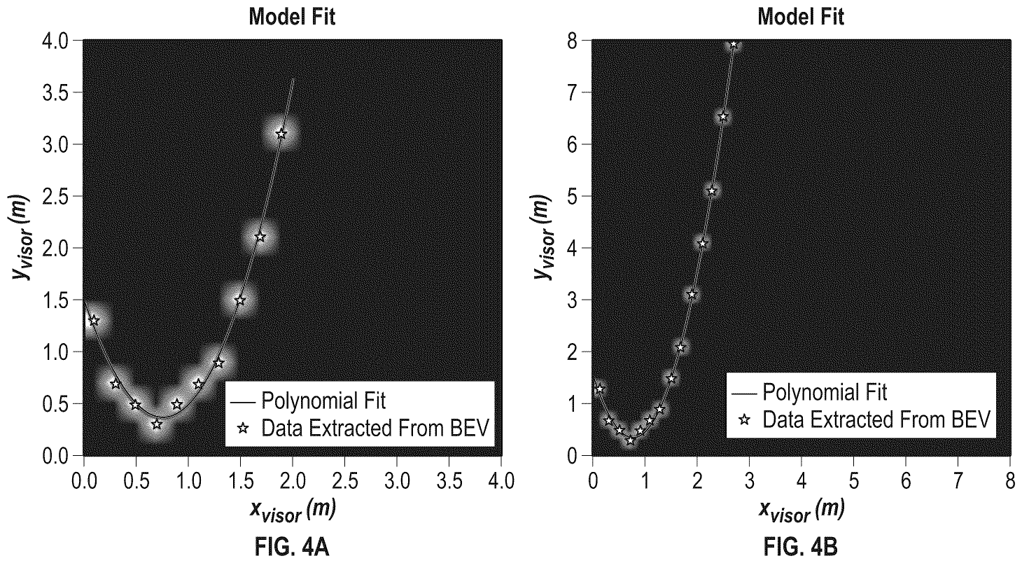

To provide additional insight into how the algorithm behaves, it was run over fully synthetic data generated in Python, the results of which are shown in FIGS. 4A and 4B. Specifically, the coefficients of a (set of) 3rd order polynomials are randomly sampled, and the BEV grid semantic segmentation is generated by setting the semantic class of all cells intersected by the polynomial to LANE_LINE. In all cases the algorithm is initialized as follows ∀ [symbol] ∈{1, . . . , L}:

$${μ}_{ℓ , 0} = {[ {c}_{ℓ , 0} , 0 , 0 ]}^{T} , where {c}_{ℓ , 0} = \frac{20 \cdot ℓ}{L + 1}$$

$${S}_{ℓ , 0} = {I}_{3}$$

$${α}_{ℓ , 0} = 1 ; and$$

$$L = 3$$

where S is represents the covariance, μ represents the mean of the function parameters, α represents the concentration parameters of the Dirichlet distribution over mixture weights, and L represents the total number of continuous functions, as described above. FIG. 4A illustrates the result of running the algorithm with 3rd order polynomial basis functions over fully synthetic data with 20 data points at 20 cm resolution. FIG. 4B illustrates the result of running the algorithm with 3rd order polynomial basis functions over fully synthetic data with 40 data points at 20 cm resolution. Each plot shows a heat map of the semantic segmentation (“hot,” e.g., gray and white shaded areas, correspond to LANE_LINE labels), with the extracted data and mean polynomial prediction superimposed. In both FIGS. 4A and 4B, the number of polygons is correctly identified as 1, and the single polynomial prediction fits well, qualitatively. This is expected given that the estimator models were used to generate the synthetic data but indicates that the algorithm works robustly in these ideal scenarios, providing evidence that the problem is, in fact, observable, the equations were derived correctly, and the implementation is free of any major bugs.

FIGS. 5A and 5B show the corresponding prediction errors and predicted 1−σ error bounds for the same 20 and 40 point examples illustrated in FIGS. 4A and 4B. Specifically, FIG. 5A illustrates prediction error and 1-Sigma bounds for the 20 data point set and FIG. 5B illustrates prediction error and 1-Sigma bounds for the 40 data point set. The circle positioned on the +1 and −1 sigma bounds depict the value of the of the 1-sigma bounds at x=3.5 for the 20 point case, overlaid on both plots for comparison. A relatively small number of data points were selected to accentuate the error characteristics. As shown, the error increases with distance from the vehicle for two primary reasons. First, the fixed amount of data, N, at a fixed grid resolution, δ, used for this problem results in the data cutting out at a fixed [symbol] -value, N·δ, beyond which the model is in pure extrapolation. The data and extrapolation ranges are called out in FIGS. 5A and 5B. Second, generally, the polynomial coefficients are more observable through data at larger [symbol] magnitudes due to the larger functional sensitivity (e.g., a small change in input, [symbol] , maps to a larger change in output, [symbol] , at larger magnitudes of [symbol] ). The same observability/sensitivity argument can be made for the predictive distribution, in that error/uncertainty in the polynomial coefficient estimates map into larger model prediction errors at larger | [symbol] | after being propagated through the polynomial equation. Specifically, error in the zeroth order coefficient maps to a constant bias in the model prediction across all | [symbol] |; error in the first order coefficient maps to a prediction error that linearly increases with | [symbol] |; error in the second order coefficient maps to a prediction error that increases quadratically with | [symbol] |, and so on.

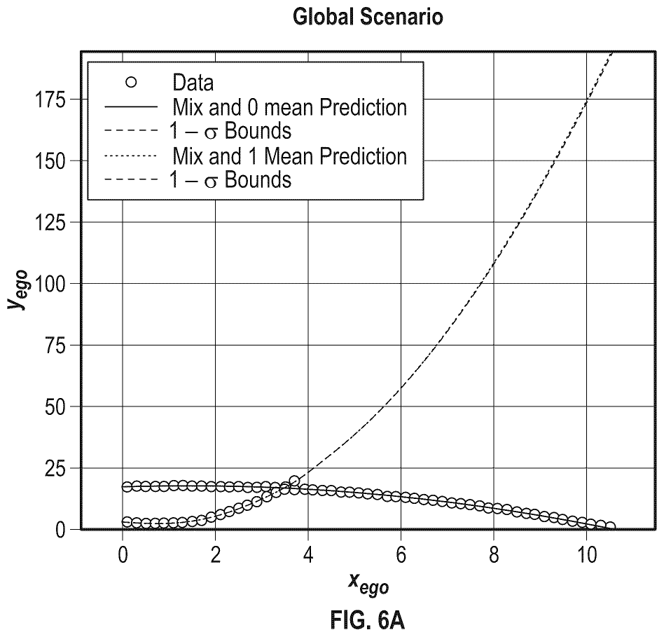

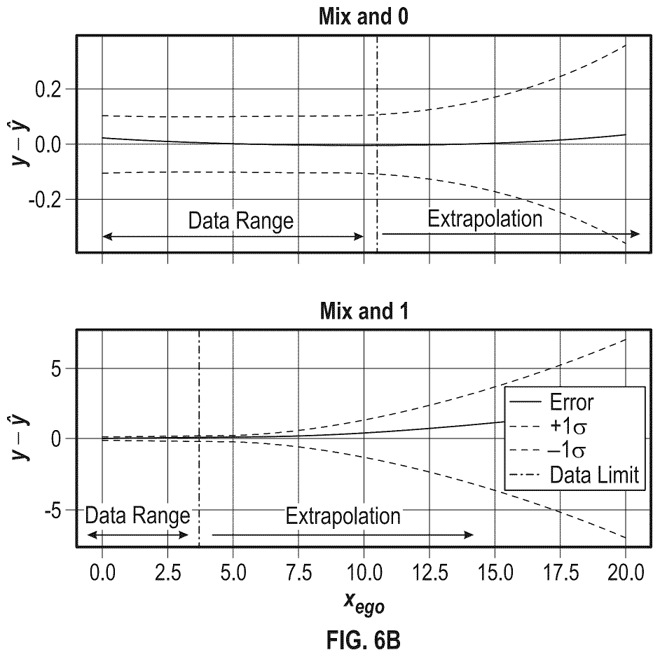

FIGS. 6A and 6B illustrate results of the same fully synthetic problem setup described with reference to FIGS. 4A-4B and 5A-5B run over fully synthetic data generated from 2 intersecting polynomials to demonstrate the algorithm is robust to intersecting polygons where data responsibilities (e.g., probabilities that data points are explained by a function) can become ambiguous. FIG. 6A illustrates the extracted data, predicted mean, and predicted 1-sigma ellipse for each polygon and FIG. 6B illustrates the error and predicted 1-sigma bounds for each estimated continuous function.

FIG. 7 depicts an exemplary computing device 700, in accordance with one or more examples of the disclosure. Device 700 can be a host computer connected to a network. Device 700 can be a client computer or a server. As shown in FIG. 7, device 700 can be any suitable type of microprocessor-based device, such as a personal computer, workstation, server, or handheld computing device (portable electronic device) such as a phone or tablet. The device can include, for example, one or more of processors 702, input device 706, output device 708, storage 710, and communication device 704. Input device 706 and output device 708 can generally correspond to those described above and can either be connectable or integrated with the computer.

Input device 706 can be any suitable device that provides input, such as a touch screen, keyboard or keypad, mouse, or voice-recognition device. Output device 708 can be any suitable device that provides output, such as a touch screen, haptics device, or speaker.

Storage 710 can be any suitable device that provides storage, such as an electrical, magnetic, or optical memory, including a RAM, cache, hard drive, or removable storage disk. Communication device 704 can include any suitable device capable of transmitting and receiving signals over a network, such as a network interface chip or device. The components of the computer can be connected in any suitable manner, such as via a physical bus or wirelessly.

Software 712, which can be stored in storage 710 and executed by processor 702, can include, for example, the programming that embodies the functionality of the present disclosure (e.g., as embodied in the devices as described above).

Software 712 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 710, that can contain or store programming for use by or in connection with an instruction execution system, apparatus, or device.

Software 712 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 700 can implement any operating system suitable for operating on the network. Software 712 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for predicting lane line locations, the method comprising:
detecting, by one or more sensors on a vehicle, image data comprising a first portion of one or more lane lines of a roadway;
determining a plurality of location points indicating locations of the one or more lane lines based on the image data;
determining one or more continuous functions to respectively represent the one or more lane lines based on the plurality of location points, wherein determining the one or more continuous functions comprises determining a plurality of responsibility metrics indicating respective likelihoods that each continuous function represents a lane line; and
predicting a location of a second portion of one or more lane lines on the roadway based on the one or more continuous functions and the plurality of responsibility metrics.

2. The method of claim 1, wherein determining the plurality of responsibility metrics comprises:
determining a respective probability that each of the location points corresponds to each of the one or more continuous functions; and
determining a responsibility metric corresponding to each of the one or more continuous functions based on the probability that each of the location points corresponds to the respective continuous function.

3. The method of claim 1, wherein determining the one or more continuous functions comprises determining that at least one of the one or more continuous functions does not represent a lane line based on the plurality of responsibility metrics; and filtering the at least one continuous function from the one or more continuous functions.

4. The method of claim 1, wherein determining the one or more continuous functions comprises:
determining a first plurality of hyperparameters at a first time;
determining a respective probability that each of the location points corresponds to each of the one or more continuous functions based on the first plurality of hyperparameters;
determining an updated plurality of hyperparameters at a second time after the first time based on the respective probability that each of the location points corresponds to each of the one or more continuous functions based on the first plurality of hyperparameters.

5. The method of claim 4, wherein the updated plurality of hyperparameters is set to maximize a variational distribution over a plurality of parameters of the one or more continuous functions.

6. The method of claim 4, wherein determining the one or more continuous functions comprises:
determining that a convergence criterion is not satisfied based on an initial joint probability distribution evaluated at a first expected value of the plurality of parameters determined based on the first plurality of hyperparameters and an updated joint probability distribution evaluated at a second expected value of the plurality of parameters determined based on the updated plurality of hyperparameters;
replacing the first plurality of hyperparameters with the updated plurality of hyperparameters; and
determining a second updated joint probability distribution at a third time based on the plurality of updated hyperparameters.

7. The method of claim 6, wherein determining that the convergence criteria is not satisfied comprises determining that a difference between the updated probability distribution and the initial probability distribution exceeds a threshold.

8. The method of claim 1, further comprising: controlling an autonomous vehicle based on the predicted location of the second portion of the one or more lane lines.

9. The method of claim 1, further comprising: displaying the predicted location of the second portion of the one or more lane lines on a user interface of a vehicle.

10. The method of claim 1, wherein determining the plurality of location points indicating locations of the one or more lane lines based on the image data the image data comprises:
determining a two-dimensional grid of cells based on the image data;
assigning at least one semantic label and at least one confidence value associated with the at least one semantic label to each cell, wherein the at least one semantic label and the at least one confidence value are indicative of whether the cell includes a lane line; and
extracting a centroid from each cell that is assigned a semantic label indicating that the cell includes a lane line and a confidence value exceeding a threshold.

11. The method of claim 1, wherein the one or more continuous functions comprise a continuous parametric function.

12. The method of claim 10, wherein the continuous parametric function comprises a polynomial function.

13. The method of claim 1, wherein the one or more continuous functions are determined for at least a subset of a predefined maximum number of lane lines.

14. The method of claim 1, wherein predicting the location of the second portion of the one or more lane lines comprises predicting a probability distribution over an output of the one or more continuous functions.

15. The method of claim 1, wherein predicting the location of the second portion of the one or more lane lines comprises predicting an output based on a function that comprises a two-dimensional curve corresponding to the location of the one or more lane lines along the roadway.

16. The method of claim 1, wherein the predicted location of the second portion of the one or more lane lines based on the one or more continuous parametric functions is limited to a predefined distance from the vehicle.

17. The method of claim 1, wherein predicting the location of the second portion of the one or more lane lines comprises predicting a location envelope of the one or more lane lines based on an error function.

18. The method of claim 1, wherein predicting the location of the second portion of the one or more lane lines comprises predicting a location of at least one lane line in a region out of range of the one or more sensors.

19. A system for predicting lane line locations, the system comprising one or more processors and memory storing one or more computer programs that include computer instructions, which when executed by the one or more processors, cause the system to:
detect, by one or more sensors on a vehicle, image data comprising a first portion of one or more lane lines of a roadway;
determine a plurality of location points indicating locations of the one or more lane lines based on the image data;
determine one or more continuous functions to respectively represent the one or more lane lines based on the plurality of location points, wherein determining the one or more continuous functions comprises determining a plurality of responsibility metrics indicating respective likelihoods that each continuous function represents a lane line; and
predict a location of a second portion of one or more lane lines on the roadway based on the one or more continuous functions and the plurality of responsibility metrics.

20. A non-transitory computer readable storage medium storing instructions for predicting lane line locations, the instructions configured to be executed by one or more processors of a computing system to cause the system to:
detect, by one or more sensors on a vehicle, image data comprising a first portion of one or more lane lines of a roadway;
determine a plurality of location points indicating locations of the one or more lane lines based on the image data;
determine one or more continuous functions to respectively represent the one or more lane lines based on the plurality of location points, wherein determining the one or more continuous functions comprises determining a plurality of responsibility metrics indicating respective likelihoods that each continuous function represents a lane line; and
predict a location of a second portion of one or more lane lines on the roadway based on the one or more continuous functions and the plurality of responsibility metrics.
